(19) United States
(12) Patent Application Publication
(10) Pub. No.: US 2013/0166646 A1
(43) Pub. Date: Jun. 27, 2013

(54) METHOD AND APPARATUS FOR PROVIDING SOCIAL NETWORK SERVICES BASED ON CONNECTIVITY INFORMATION

(71) Applicants: Ian Justin Oliver, Soderkulla (FI); Sergey Boldyrev, Soderkulla (FI); Jari-Jukka Harald Kaaja, Jarvenpaa (FI); Mikko Aleksi Uusitalo, Helsinki (FI)

(72) Inventors: Ian Justin Oliver, Soderkulla (FI); Sergey Boldyrev, Soderkulla (FI); Jari-Jukka Harald Kaaja, Jarvenpaa (FI); Mikko Aleksi Uusitalo, Helsinki (FI)

(73) Assignee: Nokia Corporation, Espoo (FI)

(21) Appl. No.: 13/337,862

(22) Filed: Dec. 27, 2011

(51) Int. Cl. G06F 15/16

(52) U.S. Cl. 709/204

(57) ABSTRACT

An approach is provided for providing social network services based on connectivity information. A social network management platform provides processing and/or facilitating a processing of connectivity information associated with one or more devices to determine one or more social networks among the one or more devices. The social network management platform also determines to cause, to recommend, or a combination thereof a creation, a modification, an initiation, or a combination thereof of the one or more social networks

### BACKGROUND

Mobile devices with various methods of connectivity are now for many people becoming the primary gateway to the internet and also a major storage point for personal information. This is in addition to the normal range of personal computers and furthermore sensor devices plus internet based providers. Combining these devices together and lately the applications and the information stored by those applications is a major challenge of interoperability. This can be achieved through numerous, individual and personal information spaces in which persons, groups of persons, etc. can place, share, interact and manipulate (or program devices to automatically perform the planning, interaction and manipulation of) webs of information with their own locally agreed semantics without necessarily conforming to an unobtainable, global whole.

Furthermore, in addition to information, the information spaces may be combined with webs of shared and interactive computations or computation spaces so that the devices having connectivity to the computation spaces can have the information in the information space manipulated within the computation space environment and the results delivered to the device, rather than the whole process being performed locally in the device. It is noted that such computation spaces may consist of connectivity between devices, from devices to network infrastructure, to distributed information spaces so that computations can be executed where enough computational elements are available. These combined information spaces and computation spaces often referred to as computation clouds, are extensions of the ‘Giant Global Graph’ in which one can apply semantics and reasoning at a local level.

One of the rapidly growing groups of networks with complex interconnections and exchange of high volumes of information among devices are social networks, wherein devices are tied by one or more specific type of interdependency such as, for example, friendship, kinship, common interests, financial exchange, dislike, relationships, knowledge, proximity, etc.

Networks composed of mobile and immobile devices associated with the wide spectrum of distributed information and computation spaces communicate with each other via methods of connectivity based on various paradigms of communication (or radio) such as, for example, cognitive radio wave, telephony, fiber optics, orbiting satellites, the Internet, etc. A recent development in radio communication technology referred to as “cognitive radio” provides a paradigm for wireless communication in which either a network or a wireless node changes its transmission or reception parameters to communicate efficiently while avoiding interference with licensed or unlicensed users. In one embodiment, this alteration of parameters is based, at least in part, on the active monitoring of several factors in the external and internal radio environment, such as radio frequency spectrum, user behavior and network state. By way of example, cognitive radio provides many advantages over traditional radio communication paradigms, for example, by (1) enabling use of all available frequencies leading to efficient use of the radio spectrum, (2) providing easy control and verification of identity, (3) providing new levels of interaction among various radio types, etc.

It is noted that, because of the benefits of cognitive radio, many social network providers 109a-109k may opt for using cognitive radio as their preferred way of communication in order to provide more and more connectivity between people. However, currently, the connectivity information such as, for example, various policies (e.g., restrictions, privacy, connectivity, etc.) associated with the communicating parties (e.g., devices, users, etc.), or with communication services provided by cognitive radio communication are not considered in creation or modification of social groups associated with social networks, and this affects the efficiency of the currently available social networks.

### SOME EXAMPLE EMBODIMENTS

Therefore, there is a need for an approach for providing social network services based on connectivity information.

According to one embodiment, a method comprises processing and/or facilitating a processing of connectivity information associated with one or more devices to determine one or more social networks among the one or more devices. The method also comprises determining to cause, to recommend, or a combination thereof a creation, a modification, an initiation, or a combination thereof of the one or more social networks.

According to another embodiment, an apparatus comprises at least one processor, and at least one memory including computer program code for one or more computer programs, the at least one memory and the computer program code configured to, with the at least one processor, cause, at least in part, the apparatus to process and/or facilitate a processing of connectivity information associated with one or more devices to determine one or more social networks among the one or more devices. The apparatus is also caused to determine to cause, to recommend, or a combination thereof a creation, a modification, an initiation, or a combination thereof of the one or more social networks.

According to another embodiment, a computer-readable storage medium carries one or more sequences of one or more instructions which, when executed by one or more processors, cause, at least in part, an apparatus to process and/or facilitate a processing of connectivity information associated with one or more devices to determine one or more social networks among the one or more devices. The apparatus is also caused to determine to cause, to recommend, or a combination thereof a creation, a modification, an initiation, or a combination thereof of the one or more social networks.

According to another embodiment, an apparatus comprises means for processing and/or facilitating a processing of connectivity information associated with one or more devices to determine one or more social networks among the one or more devices. The apparatus also comprises means for determining to cause, to recommend, or a combination thereof a creation, a modification, an initiation, or a combination thereof of the one or more social networks.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing social network services based on connectivity information, according to one embodiment;

FIG. 2 is a diagram of the components of a social network management platform, according to one embodiment;

FIG. 3 is a flowchart of a process for providing social network services based on connectivity information, according to one embodiment;

FIGS. 4A-4C are diagrams of functional flows of the social network management, according to various embodiments;

FIG. 5 is a diagram of information sharing on the boundaries of multiple social networks, according to one embodiment;

FIG. 6 is a diagram of TV white space cognitive radio architecture with privacy, according to one embodiment;

FIG. 7 is a diagram of using cloud environment for sharing cognitive radio information, according to one embodiment;

FIG. 8 is a diagram of mapping between cloud environment and cognitive radio environment, according to one embodiment;

FIG. 9 is a diagram of an information space architecture used for providing cognitive radio information sharing, according to one embodiment;

FIG. 10 is a diagram of hardware that can be used to implement an embodiment of the invention;

FIG. 11 is a diagram of a chip set that can be used to implement an embodiment of the invention; and

FIG. 12 is a diagram of a mobile terminal (e.g., handset) that can be used to implement an embodiment of the invention.

### DESCRIPTION OF SOME EMBODIMENTS

Examples of a method, apparatus, and computer program for providing social network services based on connectivity information are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term social network refers to networks or groups of devices that are tied by one or more specific type of interdependency such as, for example, friendship, kinship, common interests, financial exchange, dislike, relationships, knowledge, proximity, etc. In some embodiments, a social network can be based, at least in part, on a long range remote network among distributed devices (e.g. via LAN, WAN, WLAN, WiFi, etc.), a local short range network (via near field communication using technologies such as Bluetooth®, RF memory tags, etc.), or a combination thereof. By way of example, a social network can be dynamically built, prebuilt, terminated, suspended and resumed or matured over time, place, distance, locality, people, or a combination thereof with optimal connectivity and privacy taken into account.

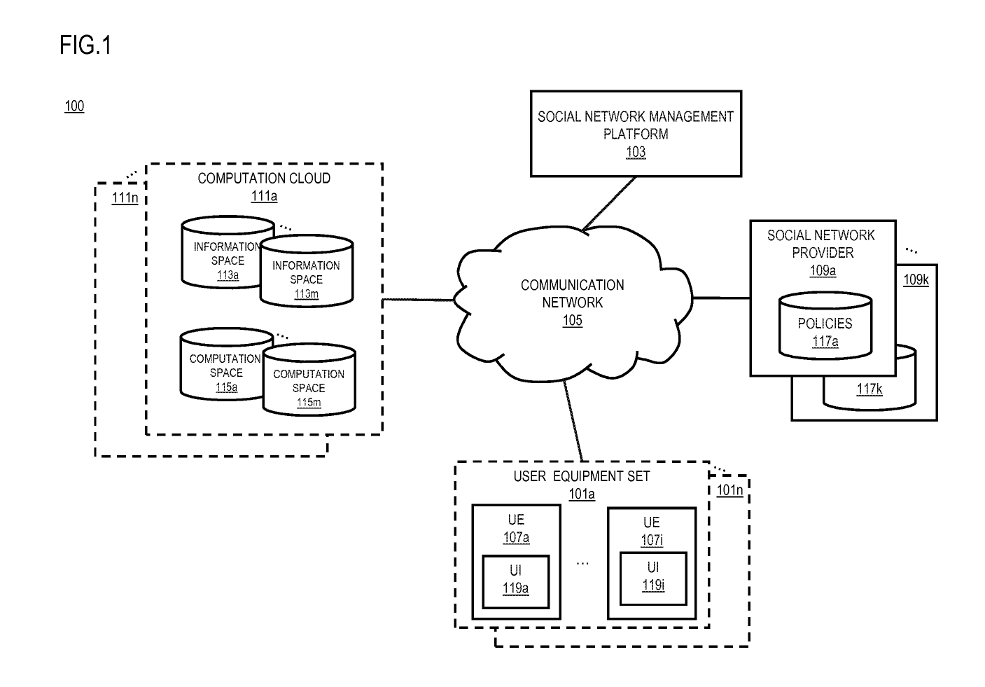

FIG. 1 is a diagram of a system capable of providing social network services based on connectivity information, according to one embodiment. In one embodiment, combining restricted social networks with connectivity and privacy mechanisms, provide better user experience. In this embodiment, social networks can be created, modified, updated, terminated, etc. based on retrieved connectivity and privacy enabler information, wherein privacy enabler functions as a gatekeeper between the information requesting component and other components of the cognitive radio environment and filters the sensitive information.

In one embodiment, cognitive radio capable devices applied to social networks can form group optimized connectivity with selected preferences by means of some social networks such as, for example, Nokia Circles®, Facebook®, Google+®, etc. Such social networks can have different restriction levels based on privacy enabler settings and operations, which may affect the stability of communities and determine how much optimal cognitive radio connectivity is bounded with those restrictions of social networks.

In one embodiment, a social network can be dynamically built, prebuilt, terminated, suspended and resumed or matured over the time, place, people, or a combination thereof with optimal connectivity and privacy enabler settings taken into account. Certain time or place or people applied with privacy enabler may initiate such social network establishment, re-establishments, temporary suspension, or apply other restrictions with the help of cognitive radio connectivity functionalities or other wireless technologies such as, for example, short range or close proximity radio, etc.

The cloud computing environments provide aggregated sets of information (information spaces) and computations (computation spaces) from different sources. This multi-sourcing is very flexible since it accounts and relies on the observation that the same piece of information or computation can come from different sources. In one embodiment, information and computations within the cloud are represented using Semantic Web standards such as Resource Description Framework (RDF), RDF Schema (RDFS), OWL (Web Ontology Language), FOAF (Friend of a Friend ontology), rule sets in RuleML (Rule Markup Language), etc. Furthermore, as used herein, RDF refers to a family of World Wide Web Consortium (W3C) specifications originally designed as a metadata data model. It has come to be used as a general method for conceptual description or modeling of information and computations that is implemented in web resources; using a variety of syntax formats.

The basic concept of information space technology provides access to distributed information for various devices within the scope of the cloud, in such a way that the distributed nature of the information is hidden from users and it appears to a user as if all the information exist on the same device. The information spaces also enable a user to have control over information distribution by transferring information between devices that the user has access to. For example, a user may want to transfer information among work devices, home devices, and portable devices, other private and public devices, etc. Furthermore, as computing environments become more and more personalized as well as localized, the need for more sophisticated sharing mechanisms between information spaces increases. These sharing mechanisms while at the outset appear to be simple union and partitioning of the information proved more difficult because of the internal interactions of the information and the semantic structures governing that information. For example, operations such as split (dividing an information space into two or more, smaller information spaces), merge (joining two or more information spaces into larger information spaces), projection (extracting information from an information space), injection (adding information to an existing information space), etc. facilitate sharing information among devices.

In one embodiment, various cognitive radio databases may be provided by different sources such as government agencies, private companies, etc. via clouds. Company offered databases may provide information in addition to the minimum regulated information available and aim at providing services using that information. The cognitive radio database, for example in TV white space spectrum (or the unused TV spectrum), or in other cognitive radio technologies, such as a coexistence providers, can offer locally relevant information on options for connectivity. Content delivery can be optimized after taking this information into account. The cognitive radio network may be capable of adjusting used services at regional level, such as grouping optimized cognitive radio enabled restricted social networks.

In one embodiment, the cognitive radio enables multidimensional social networks with different levels of information sharing (with privacy enabler aspect). The cognitive radio enables restricted social networks that provide limited communication capabilities, but at the same time are equipped with both contextual and regional properties. The level of service provided combined with the level of information trading, provides a basis of communication among different restricted social networks.

The system 100 of FIG. 1 introduces the capability to provide social network services based on connectivity information. In one embodiment, the creation of new social networks and modification of existing social networks provided by the social network providers 109a-109k are provided on the basis of connectivity information (e.g., regional databases, historical connectivity, shared context, etc.) and privacy enabler information (e.g., restrictions identified in policies 117a-117k). The connectivity information may be provided by the local storages of UEs 107a-107i, the social network providers 109a-109k, the information spaces 113a-113m of computation clouds 111a-111n, local storages of the social network management platform 103, local storages associated with the cognitive radio providers (not shown), providers of services other than social networks (not shown), or a combination thereof.

In one embodiment, various components associated with cognitive radio such as, for example, regional databases, contextual managers, etc. are utilized for underpinning a restricted type of social networking, in which, for example, usage of group optimized connectivity and aligned needs is connected with notion of a valuable user (e.g. a social blogger) of a UE 107a-107i who can initiate or join various groups of the social networks. Once joined an existing or initiated a new social network, the user can increase the value of social interaction within the network or within the groups of the network which in return can be traded in for various services from different service providers.

In one embodiment, a value associated with a user of UE 107a-107i, a service provided via communication network 105, or a combination can create a framework of monetized sharing capabilities within a number of social networks or groups associated with the social networks provided by social network providers 109a-109k. This capability can stimulate and encourage increasing the value of groups in order to trade the valuable information agreed in consensus with other participants of such groups (e.g., other users of UEs 107a-107i).

In one embodiment, the privacy aspect of information is considered as directly dependant on such consensus among group participants, since once agreed the information within the group can be traded, similar to stocks, for service. In one embodiment, the granularity of trades can be aligned with the social threads and/or embedded messages, but not limited with.

In one embodiment, the social networks, social groups, or a combination thereof, can have different restriction levels, which affect the stability of social communities and availability of interactions between restricted social networks/groups. In one embodiment, optimal cognitive radio connectivity is bounded with the restrictions of social networks/groups. On the other hand, social networks/groups may be bounded with the restrictions of available connectivities (e.g., cognitive radio or other radios). Social networks can be dynamically built, prebuilt, or matured over the time/place/people with optimal cognitive radio connectivity taken into account.

In various embodiments, certain time or place or people may initiate social networks/groups establishment at present time, in the future, or a combination thereof, with help of cognitive radio connectivity functionalities. For example, the conditions as to whether one or more cognitive radio capable devices 107a-107i are available at a certain time, at a certain place or by certain users utilizing them, may initiate building or rebuilding a social network/group or start inviting other users to join a social network/group for communication. There may also be conditional initiation, wherein the building or rebuilding a social network/group is started only if certain conditions are met.

In one embodiment, cognitive radio capable devices 107a-107i have the capability to shape the structure of the created social networks/groups, bounded to certain regions, users, times, etc. Each social network/group may have its own preferences and establish tight or loose information sharing boundaries with other social networks/groups. Such boundaries are managed by the social network management platform 103 based on the policies and rules provided by social network provides 109a-109k via policies 117a-117k.

In one embodiment, the UEs 107a-107i store information associated with previous connections and connectivities. If the amount of connections (number, duration, type, etc.) to a particular other UE 107a-107i via any method (e.g., Bluetooth®, phone calls, SMS messages, near field communications, etc.) is higher than a threshold value N within a time period T shorter than another threshold, and the owners of these UEs 107a-107i are not connected via any social network/group of interest, an automatic proposal is issued by the social network management platform 103, suggesting the UEs to be linked to each other in a social network/group.

In one embodiment, the social network management platform 103 may use information such as, for example, the users to whom the user of UEs 107a-107i are already connected to (e.g., via existing social networks), connectivity information (e.g., the phonebooks of UEs 107a-107i), etc., for providing the proposal for the creation of a link among UEs 107a-107i.

In one embodiment, UEs 107a-107i having similar parameters of connectivity such as, for example, location and type of data downloaded may join the same social network/group. In this embodiment, when the social network management platform 103 recognizes the similarity among the UEs, it may propose a linking among those UEs via a social network/group.

In one embodiment, similarity information may be collected and provided by service providers, computation clouds 111a-111n, various databases associated with the cognitive radio (e.g., cognitive connectivity databases), the UEs 107a-107i, the social network management platform 103, or a combination thereof. In one embodiment, the social network management platform 103 verifies information privacy before providing information in order to avoid violation of privacy. For example, the kind of content or sources accessed by one or more UEs 107a-107i may be identified by the user as private information. Therefore, the social network management platform 103 would exclude the private information from being added to the similarity information.

In one embodiment, if there has not been any connectivity between some UEs 107a-107i over a time period of threshold T2, the social network management platform 103 may suggest a renewal of social connection among those UEs, for example, by sharing the social token, bringing the UEs into close proximity, or by any other renewal methods used for social connection.

As shown in FIG. 1, the system 100 comprises a set 101 of user equipment (UEs) 107a-107i having connectivity to a social network management platform 103 via a communication network 105. By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, close proximity networks, RF memory tag solutions, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UEs 107a-107i are any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UEs 107a-107i can support any type of interface to the user (such as “wearable” circuitry, etc.).

In one embodiment, the UEs 107a-107i are respectively equipped with one or more user interfaces (UI) 119a-119i. Each UI 119a-119i may consist of several UI elements (not shown) at any time, depending on the service that is being used. UI elements may be icons representing user contexts such as information (e.g., music information, contact information, video information, etc.), functions (e.g., setup, search, etc.) and/or processes (e.g., download, play, edit, save, etc.). These contexts may require certain sets of media dependent computation closures, which may affect the service, for example the bit error rate, etc. Additionally, each UI element may be bound to a context/process by granular distribution. In one embodiment, granular distribution enables processes to be implicitly or explicitly migrated between devices, computation clouds, and other infrastructure. Additionally, a UE 107a-107i may be a mobile device with embedded Radio Frequency (RF) tag system of device to device connections such that computational operations and content can be locally transmitted among devices.

By way of example, the UEs 107a-107i, and the social network management platform communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

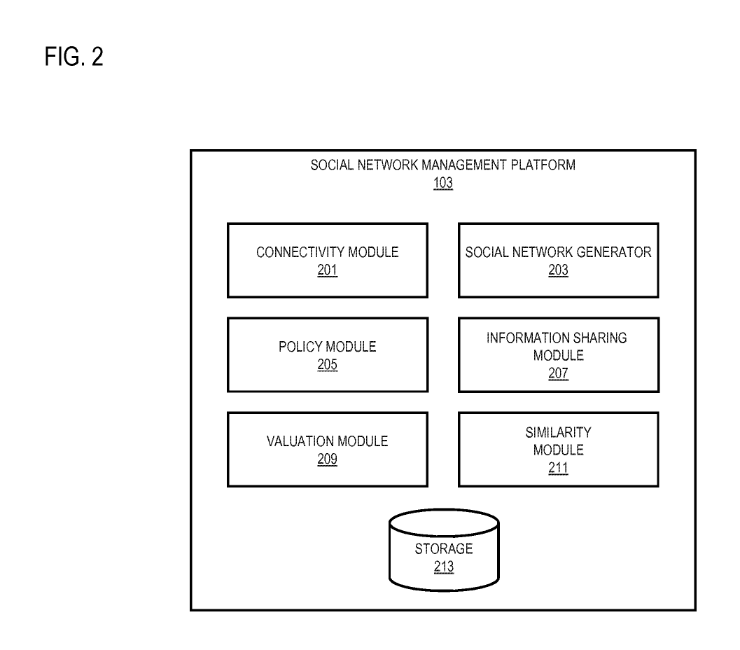

FIG. 2 is a diagram of the components of a social network management platform, according to one embodiment. By way of example, the social network management platform 103 includes one or more components for providing social network services based on connectivity information. It is contemplated that the functions of these components may be combined in one or more components or performed by other components of equivalent functionality. Additionally, the components of the social network management platform 103 may be located within the UE 107a-107i, in the vicinity of UE 107a-107i, in a different location having connectivity to the UE 107a-107i via the communication network 105, or a combination thereof. In this embodiment, the social network management platform 103 includes a connectivity module 201, a social network generator 203, a policy module 205, an information sharing module 207, a valuation module 209, a similarity module 211, and storage 213.

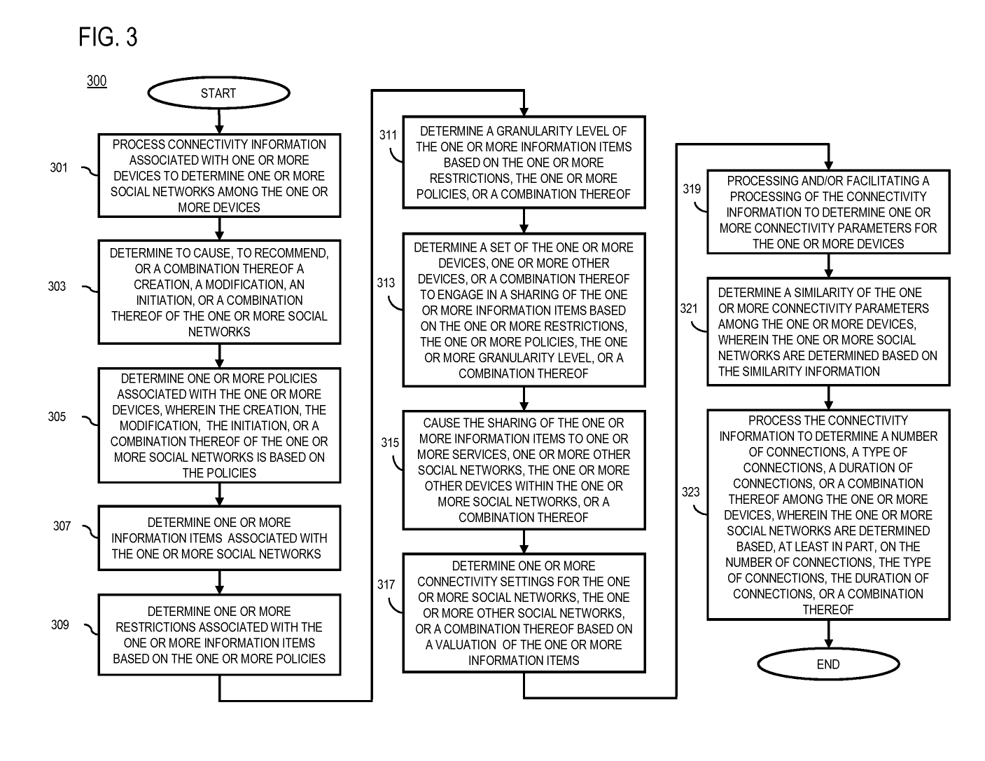

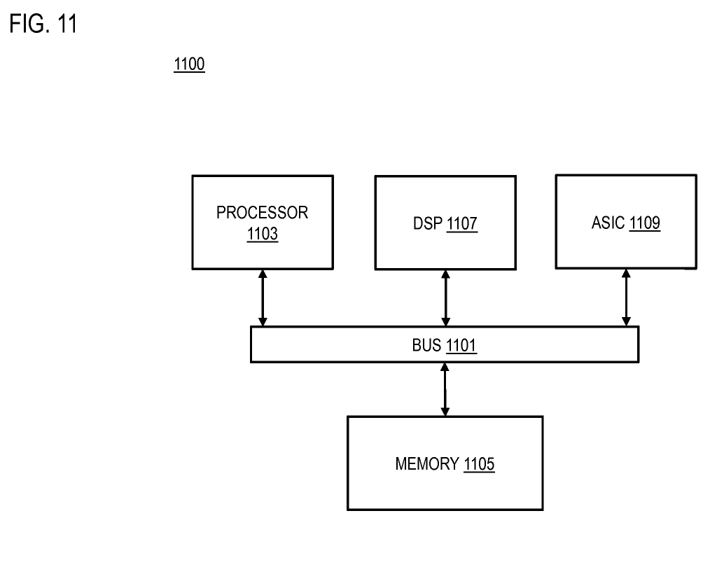

FIG. 2 is described with respect to FIG. 3, wherein FIG. 3 is a flowchart of a process for providing social network services based on connectivity information, according to one embodiment. In one embodiment, the social network management platform 103 performs the process 300 and is implemented in, for instance, a chip set including a processor and a memory as shown in FIG. 11.

In one embodiment, in step 301, of flowchart 300 of FIG. 3, the connectivity module 201 processes and/or facilitates a processing of connectivity information associated with one or more UEs 107a-107i to determine one or more social networks (or social groups within social networks) among the one or more UEs. The connectivity information may be retrieved from the UEs 107a-107i, from storage 213, from clouds 111a-111n, from social network providers 109a-109k, from one or more cognitive radio providers (not shown), or a combination thereof.

In one embodiment, per step 303 of FIG. 3, the social network generator 203 determines to cause, to recommend, or a combination thereof a creation, a modification, an initiation, or a combination thereof of the one or more social networks/groups. In one embodiment, the social network generator 203 may recommend the creation, modification, or initiation of the social networks/group to the social network provider 109a-109k. In other embodiments, the social network generator 203 may be authorized by the social network provider 109a-109k to perform the creation, modification, or initiation of the social networks/groups under the supervision of the social network provider 109a-109k.

In one embodiment, per step 305 of FIG. 3, the policy module 205 determines one or more policies associated with the one or more UEs 107a-107i from the policies 117a-117k, from storage 213, or a combination thereof. The one or more policies may include, at least in part, one or more privacy policies, one or more security policies, or a combination thereof. In one embodiment, the social network generator 203 causes or recommends the creation, modification, or initiation of the one or more social networks/groups based, at least in part, on the one or more policies.

In one embodiment, per step 307 of FIG. 3, the information sharing module 207 determines one or more information items associated with the one or more social networks/groups. The information items may include social threads, embedded messages, communication histories, etc. Furthermore, the information items may be retrieved from storage 213, from social network providers 109a-109k, from computation cloud 111a-111n, or a combination thereof.

In one embodiment, per step 309 of FIG. 3, the policy module 205 determines one or more restrictions associated with the one or more information items based, at least in part, on the one or more policies from policies 117a-117k. The one or more restrictions may determine limits of information sharing allowed for each UE 107a-107i.

In one embodiment, per step 311 of FIG. 3, the information sharing module 207 determines a granularity level of the one or more information items based, at least in part, on the one or more restrictions determined per step 309, the one or more policies, or a combination thereof.

In one embodiment, per step 313 of FIG. 3, the information sharing module 207 determines a set of the one or more UEs 107a-107i, one or more other UEs 107a-107i, or a combination thereof to engage in a sharing of the one or more information items based, at least in part, on the one or more restrictions determined per step 309, the one or more policies from policies 117a-117k, the one or more granularity levels determined per step 311, or a combination thereof.

In one embodiment, per step 315 of FIG. 3, the information sharing module 207 causes, at least in part, a sharing of the one or more information items to one or more UEs 107a-107i, one or more other social networks, the one or more other UEs 107a-107i within the one or more social networks, or a combination thereof, wherein the sharing of the one or more information items is based, at least in part, on the one or more restrictions, on the granularity level, or a combination thereof.

In one embodiment, per step 317 of FIG. 3, the valuation module 209 determines a valuation of the one or more information items. The valuation may be determined, for example, based on the status of the user of a UE 107a-107i who is the owner of the information items. For example, the information items associated with a celebrity, an activist, or any other famous figures may be assigned a higher value compared to an ordinary user. Additionally, the valuation may take into account whether the information is from an ordinary user, or from an opinion leader. If latter case, the value and effect of the information on the status of the social network can be more significant.

In one embodiment, the connectivity module 201 determines one or more connectivity settings for the one or more social networks, the one or more other social networks, or a combination thereof based, at least in part, on the valuation of the one or more information items provided by the valuation module 209. In one embodiment, the valuation may be used for monetizing the information items which in turn can be used for trading of the information items among UEs 107a-107i within the scope of the social networks/groups they belong to.

In one embodiment, the one or more connectivity settings by the connectivity module 201 are further based, at least in part, on the one or more restrictions determined per step 309, the one or more policies from policies 117a-117k, one or more other restrictions associated with the one or more other social networks, one or more other policies associated or a combination thereof. In this embodiment, the social networks/group with common boundaries (for example, common member UEs) can negotiate for sharing, exchanging, trading, or a combination thereof of the information items among themselves.

In one embodiment, per step 319 of FIG. 3, the similarity module 211 processes and/or facilitates a processing of the connectivity information provided by the connectivity module 201, to determine one or more connectivity parameters for the one or more UEs 107a-107i. Subsequently, per step 321 of FIG. 3, the similarity module 211 determines a similarity of the one or more connectivity parameters among the one or more UEs, wherein the one or more social networks/groups are determined by the information sharing module 207 based, at least in part, on the similarity information. The similarity module 211 may also collect similarity tokens as input for decision criteria for the information sharing module 207.

In one embodiment, per step 323 of FIG. 3, the connectivity module 201 processes and/or facilitates a processing of the connectivity information to determine a number of connections, a type of connections, duration of connections, or a combination thereof among the one or more UEs 107a-107i. The one or more social networks/groups are determined by the information sharing module 207 based, at least in part, on the number of connections, the type of connections, the duration of connections, or a combination thereof.

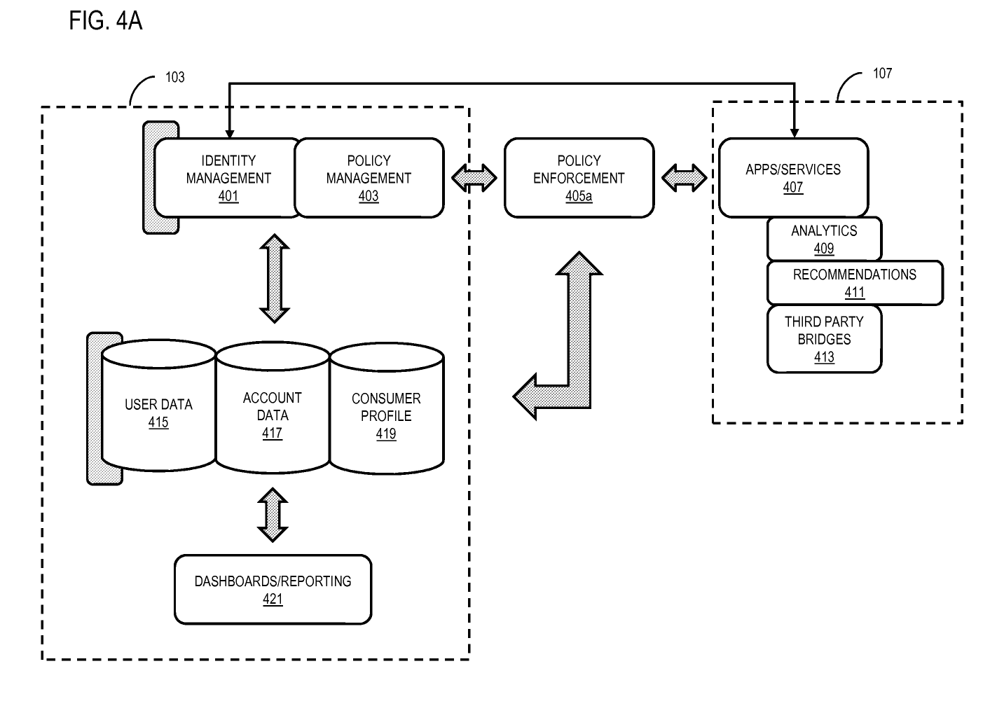

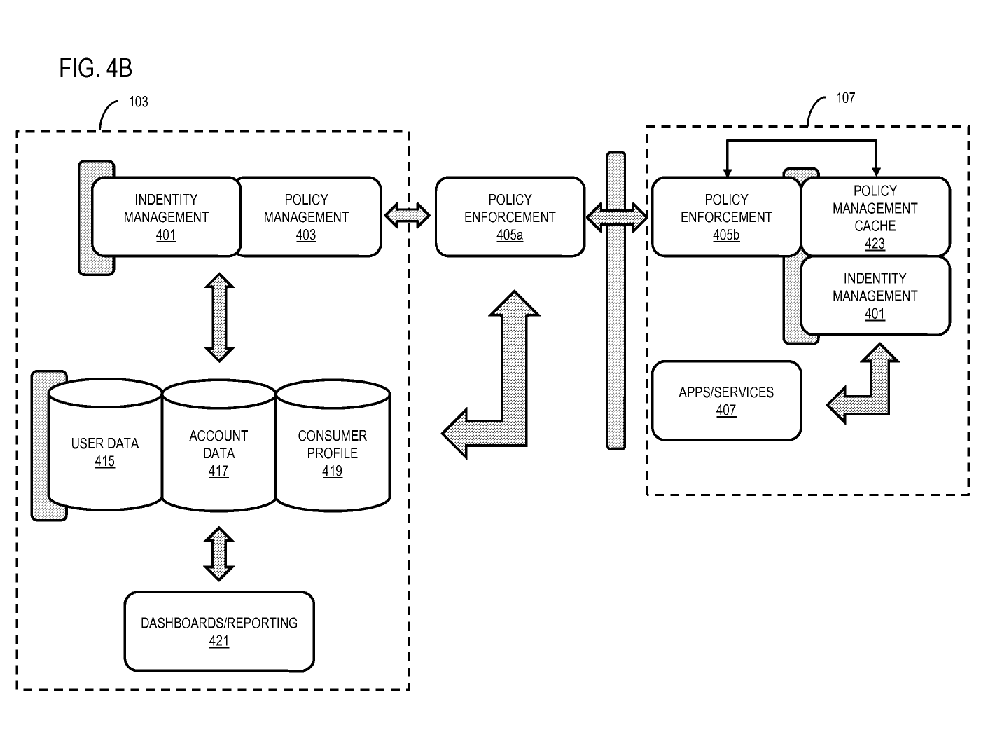

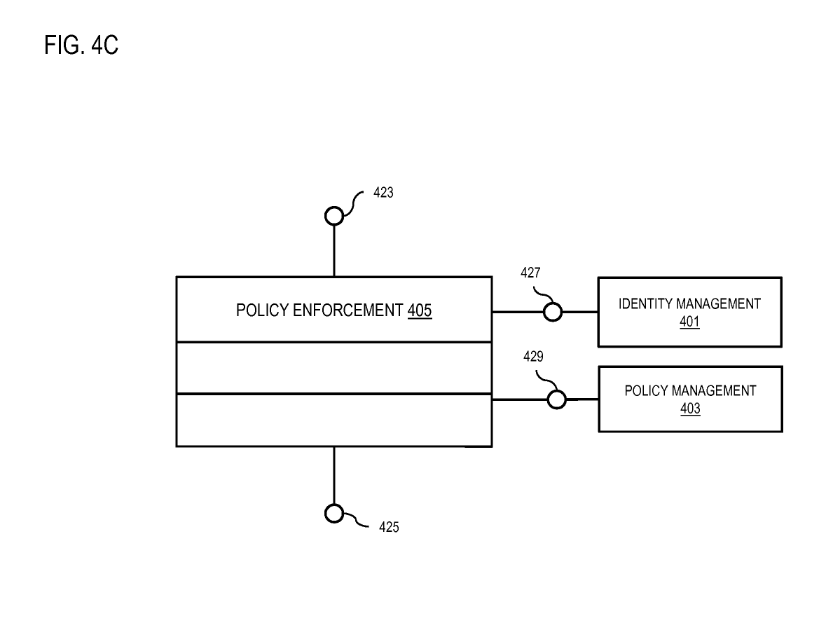

FIGS. 4A-4C are diagrams of functional flows of the social network management, according to various embodiments. The functions of the social network management platform 103 can be divided into various functional components. In one embodiment, as seen if FIG. 4A, the UE 107 may have applications/services 407, wherein the applications/service 407 may constitute a group of functional components. The applications/services 407 may include, for example, analytics 409, recommendation mechanisms 411 (used by the social network generator 203 for making social network creation or modification proposals), user applications (not shown), third party applications and bridges 413, etc.

In one embodiment, the social network management platform 103 may perform identity management 401, and policy management 403, wherein the identity management 401 may constitute another group of functional components. For example, a Single Sign-On (SSO) mechanism may be used for controlling access to the information items associated with UEs 107a-107i.

Similarly, in various embodiments, policy management 403 (performed by the policy module 205) and policy enforcement 405a (e.g., privacy enforcement) by the social network provider 109a-109k may be considered as functional components associated with the social network management platform 103.

In one embodiment, storage devices containing data such as, for example, user data 415, user account data 417, consumer profiles 419 are a type of functional components associated with the social network management platform 103. The data components 415, 417, and 419 may be stored on UEs 107a-107i, in the storage 213, at social network providers 109a-109k, on information spaces 113a-113m of clouds 111a-111n or a combination thereof. Furthermore, the computations applied by the functional flows may be retrieved from the computation spaces 115a-115m.

In one embodiment, dashboard/reporting components 421 are a type of functional components associated with the social network management platform 103. The dashboard/reporting components 421 may be considered as internal reporting components within the social network management platform 103.

It is noted that although applications/service 407, the dashboards/reporting 421, and analytics 409 may be functionally similar, however, in various embodiments each of these components may play a different role within the architecture of the social network management platform 103.

In one embodiment, various factors associated with UEs 107a-107i such as, for example, performance constraints of the UEs, off-line status of the UEs, degree of control and trust regarding the UEs, etc., are taken into consideration by the social network management platform 103. In this embodiment, as seen in FIG. 4B, a policy management cache 423 and some degree of policy enforcement 405b (for example, as much as trust can be placed on UE 107), are added to the functionalities of the UE 107.

In one embodiment, the data flow between the storages 415, 417, and 419 with the applications/services 407 via the privacy enforcement mechanism 405a and 405b is critical. This data flow is generally subject to the privacy enforcement 405a and 405b during the outbound flow, for example, from cloud 111a-111n or other storages towards the applications/services 407 as the result of a query towards the cloud or the storage.

In one embodiment, under some circumstances, inbound data flow enforcement may be needed, for example consumer data collection may be performed for the purpose of network access control, sharing scenarios, etc., particularly directly towards third parties via bridges 413. Alternatively, the data flow may be routed through system nodes via routers. The inbound data flow enforcement may map consumer data collection parts as needed/defined by targeted third parties to be analyzed, and allow the data to go through bridges and routers according to access control or sharing principles.

In one embodiment, at a server such as, for example the social network providers 109a-109k, applications/services 407 provided to UE 107 need to be online in order to be accessed and have access to the data and authentication services remotely stored, for example, on cloud 111a-111n. Alternatively, the applications/services 407 may be locally stored (e.g. embedded into one device part of the current social network connection, or in separate RF memory tag in close neighborhood) when social network is for shorter range, between UE 107 with another UE (not shown). For example, a local short range social network can be built in lecture halls or meeting rooms where users can touch a tag to get social network settings for device to device communication (e.g. with Bluetooth®/WLAN/RF memory tags) when user is in that lecture hall or meeting room.

In one embodiment, at UE 107, the limitations on connectivity inherent with mobile devices are taken into consideration. In this respect, the privacy enforcement, as part of policy enforcement 405a, may have a counterpart 405b implemented on UE 107 to ensure that policies 117a-117k are enforced even during off-line periods of UE 107. In this embodiment, the policy module 205 synchronizes the policies and stores the policies in the policy management cache 423 against the version existing in the server-side environment (e.g., 405a at the social network providers 109a-109k).

It is noted that in some cases the UE 107 may not be trusted because of the possibilities of hacking or installation of unauthorized software that can interfere with the policy enforcement process. In one embodiment, in the on-line period of UE 107 the policy enforcement 405b may be applied at the UE 107 as a best effort delivery, wherein the network cannot provide any guarantee for the proper enforcement of the policies. Alternately, the policy enforcement control may be returned to the policy enforcement 405a on server-side.

In one embodiment, in order to provide a consistent method of storing and linking data together to be used by various applications/services 407, the data may be logically partitioned, wherein a distinction is made between the data required for the systems to work (account data 417), the data 415 stored by the user (user data 415), and the explicit or implicit data describing user's identity, preferences and behavior (consumer data 419), etc. This data may also relate to the devices in use by the consumer.

In one embodiment, the physical and logical partitioning of data stored within the databases is determined during the implementation phase. However the classifications can affect application of security requirements on the stored data.

In one embodiment, in order to prevent data inconsistencies, all the data related to a user of UE 107 is linked together according to the rules of database normalization. In this embodiment, applications/services 407 are not allowed to manage and silo data individually. For example, when managing lists of friends, contact books, addresses, etc., on UE 107 only one set of data can be used, unlike currently available systems wherein two or more separate listings of contacts, addresses, etc., are being provided with little or no integration between them.

In one embodiment, the indexing and cross-referencing of the data of user of UE 107 is made according to an agreed and consistent identity management mechanism 401 such as, for example, the mechanisms via Single Sign-On (SSO) and federated identity mechanisms. In this embodiment, user identity is utilized as the key by which data is accessed and indexed. As a result, explicit relationships between users as system data (data required for the functioning of services) such as, for example, the child-parent relationship, can provide more sophisticated mechanisms for adhering to child protection laws more fully.

In one embodiment, data can be classified according to various aspects. In a cloud 111a-111n the classification can be made primarily upon the type of data as provided by the shared data model and upper data model definitions. Furthermore classifications can be considered based on cross-cutting aspects such as the ownership of the data, the provenance or system of record of the data, etc. Additionally, privacy aspects, for example, the sensitivity of the data, allowed usages of the data, the agents or entities with access to the data, etc. may be considered. Still further aspects related to access control (access credentials) and data retention can also be used for data classification.

In one embodiment, policy management 403 may be primarily concerned with the storage of policies and the addition, update and deletion of policies in the policies 117a-117k, in storage 213, in clouds 111a-111n, or a combination thereof, in a consistent manner by the correct owner.

In various embodiments, the scope of policy management 403 can be expanded to providing some rudimentary analysis of policies by the policy module 205 as well as by facilitating lockdown of policies under specific circumstances.

The user interfaces 119a-119i can be associated with the policy module 205 either explicitly or implicitly. In one embodiment, a direct access to UI 119a-119i can be explicitly provided to the policy module 205. Specific tailoring to the policy language and the dynamic nature of policies may also be taken into consideration. It is noted that, the complexity of the UI 119a-119i will vary between the full-features web-page/API (Application Programming Interface) access to more limited and targeted UIs that will be necessary to present on UEs 107a-107i.

In one embodiment, implicit UIs 119a-119i are providing changes to policies based on the users' actions. For example, when a user adds a contact C to a given group such as a family group F, the policy module 205 can modify the privacy policies related to contact C by virtue of being included in group F (for example by retrieving privacy policies for group F from the policies 117a-117k and assign them to contact C). This enables the social network management platform 103 to keep much of the privacy policy interface potentially hidden.

In one embodiment, suitable default settings for privacy can be provisioned by the social network management platform 103 by accepting the default settings provided by the social network providers 109a-109k. In other embodiments, the default settings can be extended to the provision of setup assistants (e.g. wizards) for automatic setting of private policies for a user at the time of account creation at the social network provider 109a-109k.

It is noted that, privacy enforcement (as part of the policy enforcement 405a and 4505b) can effectively act as a pass-through processor for any flow of information. In one embodiment, as seen in FIG. 4C, various interfaces can be provided for the purpose of privacy enforcement. The interface 423 in FIG. 4C is an interface for incoming data and an input to the policy enforcement 405. Similarly, interface 425 is an interface for outgoing data sending output of policy management to the recipients of such output. Additionally, the interface 427 is an interface to an authentication mechanism (e.g., SSO) associated with identity management 401. Furthermore, an interface 429 is an interface to the storage of policies (e.g., policies 117a-117k, storage 213, cloud 111a-111n, etc. or a combination) associated with policy management 403.

In one embodiment, policy enforcement 405 may be placed on the outgoing data-flow 425, for example on the query results data-flow on a database where results can be transformed as required.

The transformation of data can vary from either blocking or allowing data through (similar to access control) or to a full functional data transformation that provides mechanisms for the abstraction and anonymization of data.

In one embodiment, the interfaces 423 and 425 may be effectively identical in order to provide the option for placing the policy module 205 in a data-flow without affecting the APIs related to the data-flow. The interface 423 or 425 can be implemented in various ways such as, for example, as an integrative part of any architectural stack (e.g., as the DML (Data Manipulation Layer) in a device provider stack associated with a cloud 111a-111n), as an operating system service (e.g., as in Symbian®, etc.), as an daemon (e.g., as in Meego/Linux/Unix based systems, etc.), or a combination thereof.

In one embodiment, the particular implementation may depend on the particular environment that the interface is implemented in. However, since all policy enforcement components 405a-405b effectively obtain their policies from the same sources (e.g. policies 117a-117k); potentially more than one solution can be adopted simultaneously. For example, A UE 107a-107i may be equipped with a cloud integrative component and a daemon solution for handling the cloud 111a-111n and legacy applications.

In one embodiment, access control is present at the database level to clearly define the set of raw data that a particular user of a UE 107a-107i can see. The granularity of access control may vary, but access control is provided for the owner of the information and for those users which have access to shared data. It is noted that shared data is the data that has been explicitly shared from one user to another or by a single user across multiple applications/groups/users. The granularity of sharing may vary from sharing to an individual user, to a specific group or potentially global sharing.

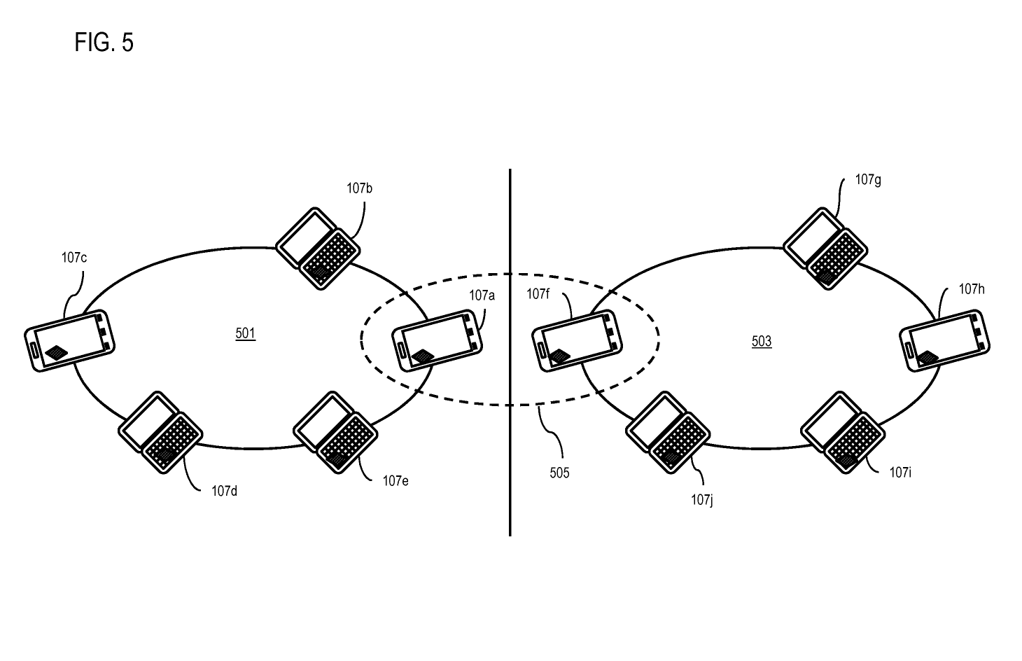

FIG. 5 is a diagram of information sharing on the boundaries of multiple social networks, according to one embodiment. In one embodiment, the process of providing social network services using connectivity information can be performed in various phases such as, for example, initiation phase, management phase, etc.

In one embodiment, as seen in FIG. 5, the circle 501 is a cognitive radio circle provided as a social network/group, for example prebuilt for UEs 107a, 107b, 107c, 107d, and 107e. It is noted that the UEs 107a-107e may be equipped with (and communicate via) Radio Frequency (RF) memory tags shown by black diamonds. The cognitive radio connectivity in circle 501 can be, for example, provided through cognitive radio TV White Space common architecture.

In one embodiment, at the initiation phase of the social network/group 501, any of the cognitive radio capable UEs 107a-107e may be able to start the phase, wherein at least one UE (e.g., 107a) sets some particular criteria for social network/group 501 establishment (at least a minimum set). Other UEs 107b-107e may negotiate, request to improve, increase or decrease the criteria.

The cognitive radio criteria may include trading and privacy rules as described with respect to FIGS. 4A-4C. In one embodiment, during the establishment of a social network/group 501, the valuation module 209 monetizes sharing capabilities of UEs 107a-107e for sharing content with other UEs such as for example UEs 107f-107j of another social network/group 503, wherein the UEs 107a-107e will gain a benefit (e.g., a service, a discount, a service improvement, etc.) in return for the content shared.

In one embodiment, upon the establishment of a social network/group 501 by a UE 107a, the connectivity module 201 selects architectural options to be applied in the social network/group 501.

In one embodiment, the social network generator 203 provides information management settings in the cognitive radio and creates or modifies a map of group optimized social networks (501, 503, etc.)

In one embodiment, the policy module 205 applies policies (e.g. privacy policies) which provide a method to draw correct social networks/groups. In one embodiment, the information sharing module 207 provides possible gateways such as, for example, group 505 composed of UEs 107a and 107f, if the sharing border (e.g. rules and policies associated with groups 501 and 503) allow. For example, the information sharing module 207 may determine users to which the groups 501 and 503 are allowed to interface. Alternatively, some of the UEs may be blocked due to, for example, place, time, people around, topic and information, contents of blacklists that have been verified against authority advices, etc. In addition, other social networks/groups that a user has already joined may advice the user not to join, disable interface towards that social group direction, etc.

In one embodiment, the information sharing module 207 supervise interaction among UEs in each group 501 and 503 and also between groups via gateway 505 through applying policies by policy module 205.

In one embodiment, the valuation module 209 may determine a weight, age, information expiration, information classification, or a combination thereof to the shared and/or traded information items. This mechanism sets the information structure within a restricted social network 501 or 503 and determines the possibility of information being elaborated, being allowed to be accessed by other social networks/groups, etc. For example privacy rules may terminate sharing of, an otherwise weighted information item, from one social network/group, to another.

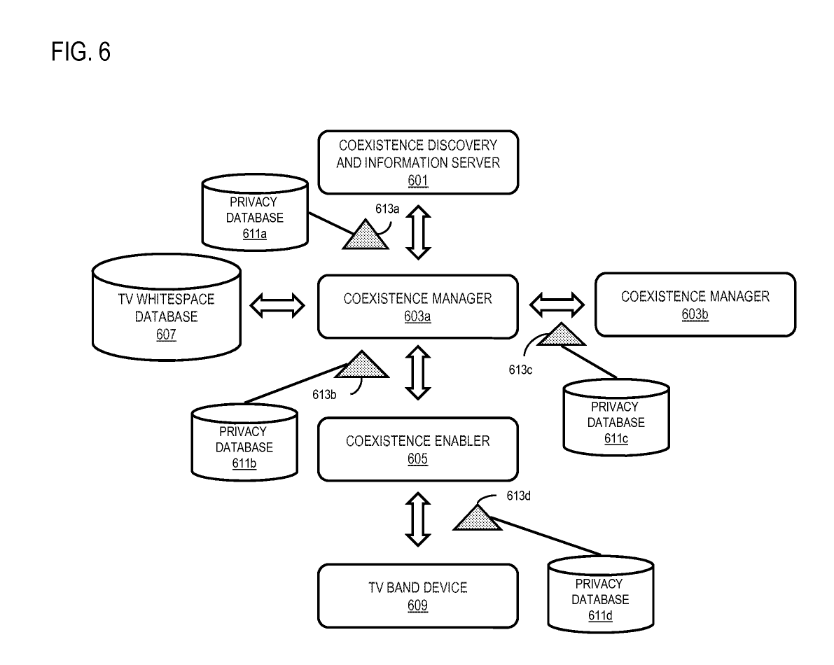

FIG. 6 is a diagram of TV white space cognitive radio architecture with privacy, according to one embodiment. In one embodiment the Coexistence Discovery and Information Server (CDIS) 601 supports discovery of Coexistence Managers (CMs) 603a in the network and collects aggregate information from other components of the network, wherein each coexistence manager 603a discovers other CMs 603b, performs decision making processes for coexistence of entities on the band, and supports exchange of information among entities and between different CMs 603a, 603b, etc. Additionally, the CMs 603a and 603b have access to the TV white space database 607 in order to discover other CMs and support exchange of information. The Coexistence Enabler (CE) 605 requests and obtains information, required for coexistence, from the TV-band Device or network (TVBD) 609, wherein TVBDs are new unlicensed radio frequency devices operating in the vacant channels or white spaces. Furthermore, the CE 605 translates reconfiguration requests and/or commands to TVBD specific format. This represents the architecture for TV white space cognitive connectivity, being standardized in IEEE 802.19.

In the embodiment of FIG. 6 the privacy enablers 613a, 613b, 613c, and 613d control the privacy of cognitive radio information sharing respectively between the coexistence discovery and information server 601 and the coexistence manager 603a, between the coexistence manager 603a and the coexistence enabler 605, between the coexistence manager 603a and the coexistence manager 603b, and between the coexistence enabler 605 and the TV band device 609. Each privacy enabler 613a-613d also has connectivity to a privacy database 611a-611d, wherein the privacy databases 611a-611d may be distributed databases communicating with each other, be components of a centralized database, or a combination thereof.

In one embodiment, the privacy enabler 613d sets the privacy client for the path between TVDB 609 and the coexistence enabler 605 to “ON” status and updates selected rules and settings in the privacy database 611d.

In one embodiment, the coexistence enabler 605 requests capabilities from the coexistence manager 603a. The privacy enabler 613b checks the privacy database 611b for answers to questions such as, “what is the cognitive enabler allowed to do?” using the privacy enabler 613b settings as parameter.

In one embodiment, the coexistence manager 603a collects information such as locations, request neighborhood (“who else is there”) etc. from the coexistence discovery and information server 601, using privacy enabler 613a settings as parameter.

In one embodiment, the coexistence manager 603a may be local while the coexistence manager 603b may be a remote coexistence manager, wherein the privacy of interaction between the coexistence managers 603a and 603b can be may provided by the privacy enabler 613c associated with the privacy database 611c.

In one embodiment, white space architecture 607 may utilize privacy policy rules for what data it is allowed to access (from upper levels of the architecture) and what it is not, for example, by setting a privacy enabler on or off. Additionally, each level of the architecture can be treated independently with privacy policy rules for what they are allowed to forward (as plain visible text, and what they are not) between the cognitive radio white space blocks. Those blocks may also have the ability to independently utilize other (or same) privacy policy rules for output data.

In one embodiment, regular users of cognitive connectivity can be offered better quality of service than the level of information they reveal would otherwise allow them to get, by joining a group such as, for example, a loyalty group. The group identity or identities are attached to the privacy information such that, as a result, the collective information on the group can be used to provide a higher class of service, a better quality of service) to the group members. For example, if users allow that their usage patterns be recorded (e.g. by joining a loyalty program), their information (including past information) can be used to optimize the quality of service. Additionally, the longer users are with a group (e.g., use the cognitive connectivity via the group), the higher their rank can be in the group which can affect the quality of service the users receive. On the other hand, accumulation of history information regarding group members enables the cognitive radio providers to provide better connectivity to the users. The more information the users reveal on themselves, the faster can they raise their rank in the group.

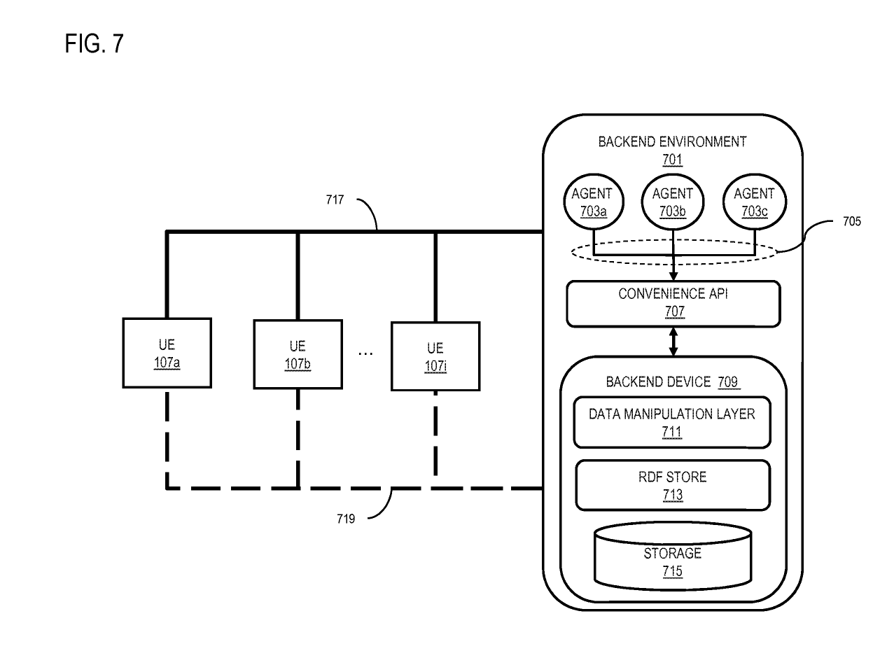

FIG. 7 is a diagram of using cloud environment for sharing cognitive radio information, according to one embodiment. In one embodiment, utilizing cloud environment 111a-111n for sharing cognitive radio information, provides broader information sharing structure than, for example, what WURFL provides. The cognitive radio structure can utilize WURFL as an interoperable service (along with other data sources), wherein the WURFL may access the backend environment 701 and provide direct cognitive radio specific access to UEs 107a, 107b, . . . , 107i with necessary parameters. If information sharing via WURFL fails to extract and provide various cognitive radio parameters such as location, frequencies, etc. any other suitable data sources (service provides) can be utilized to reconstruct such information or derive it from other data.

In one embodiment, the backend environment 701 is a network infrastructure. The backend environment may also be a virtual run-time environment within a cloud 111a-111n associated with the owner of one or more UEs 107a-107i or on another UE 107b associated with the user. The backend environment 701 may include one or more components (backend devices) 709 and one or more Application Programming Interface (API) such as a convenience API 707 that may include APIs tailored to the software development environments used (e.g. JAVA, PHP, etc.). Furthermore, UEs 107a-107i may include client APIs (not shown) each API enabling interaction between devices and components within another device or an environment. For example, the convenience API 707 enables interaction between the backend device 709 and agents 703a, 703b, and 703c, wherein each agent is a set of processes that handle computations within the backend environment 701. Connections 717 and 719 respectively represent distribution paths of data and control among the environment 701 and UEs 107a-107i. The storage 715 is a repository of information and computations that can be accessed and used by all the UEs and infrastructure components having connectivity to the backend environment 701.

In one embodiment, the backend device 709 may be equipped with a data manipulation layer 711 that monitors and manages any access to the storage 715.

In one embodiment, the social network management platform 103 extracts cognitive radio specific parameters, by sniffing, interrogation, or a combination thereof, from the backend environment 701 associated with cloud 111a-111n, and translates the parameters into specific expressions of the cognitive radio. The social network management platform 103 may also utilize storage 715, which is part of the information space 113a-113m, for storing shared cognitive radio information, white space database, or a combination thereof.

In one embodiment, one or more UEs 107a, 107b, . . . , 107i may request and inform their (spectrum) findings to the common cognitive radio database (e.g. storage 715 in the backend device 709, storage 213 of social network management platform 103, backend environment 701, or a combination thereof). In response, the backend device 709 may send settings and other response information back to configure UEs 107a-107i. The social network management platform 103 (shown in FIG. 1) may monitor correct utilization of the received settings by the UEs 107a-107i at certain locations, under certain regulations, etc.

The backend environment 701 may include several layers (e.g. L1, L2, L3) shown as circle 705, which provide fine instruments for developers to access particular layers for development. The layers 705 describe different abstraction layers attached to different convenience layers, convenience API 707. In one embodiment, the cognitive radio functions can be mapped to level L3 as a cognitive radio domain specific API. The cognitive radio domain can be built based on location, frequency and rules information.

In one embodiment, the cloud 111a-111n may have a platform API, which is specific to mobile applications, defining location, bearer, short range communications, etc., and when cognitive radio specific functions (e.g. cognitive radio domain information) are mapped into the platform API, it forms a cognitive radio specific platform API.

In one embodiment, the Data Manipulation Layer (DML) 711 provides connectivity, privacy, security policies API, which will fetch policy rules from storage 715 or any other storage spaces associated with cloud 111a-111n and apply them to the ongoing data-stream.

In one embodiment, the cognitive radio database information, is based on locations wherein each location may be under certain regulations (legislation), allowing certain frequencies to be used at the location.

In one embodiment, as previously described, there may be two options (functions) for cognitive radio specific operations, namely, sniffing (associated radio sensing and listen before talk) such as for example, transmitting, sniffing vacant channels (channel numbers, characteristics); and interrogation (with local agreement). In the interrogation method, the social network management platform 103 has knowledge of occupied channels and provides protocols for communication among UEs 107a-107i, including rules, candidate neighbors, operation and measurement configurations, etc.

In one embodiment, sniffing includes scanning the environment, whereas interrogation provides more local and global interactions, also selecting the used setup. Sniffing is a subset of interrogation, as interrogation provides more information.

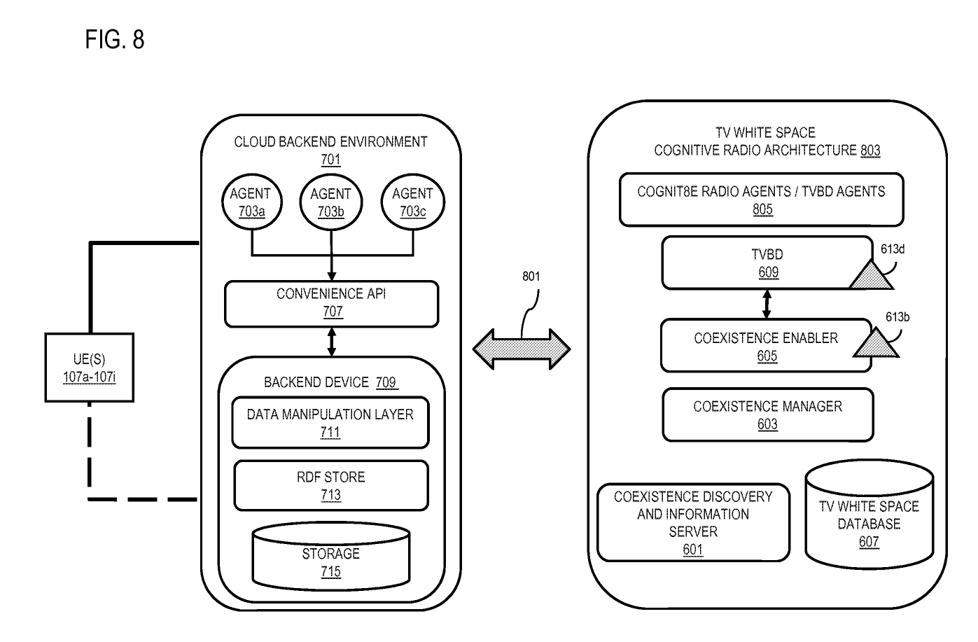

FIG. 8 is a diagram of mapping between cloud environment and cognitive radio environment, according to one embodiment. In one embodiment, the cognitive radio enabled UE 107a-107i requests the cloud backend environment 701 generalized representation, wherein the TV white space cognitive radio architecture 803 is mapped to the backend environment 701 (shown as arrow 801).

In one embodiment, the social network management platform 103 uses sniffing or interrogation methods and reutilizes the methods in the convenience API 707. The cognitive radio specific API may consist of information such as regulations, bandwidth information and their characteristics, etc. in order to provide cognitive radio specific operations, method of choice (e.g. sniff or interrogate the cognitive radio information from the environment 803).

In one embodiment, mapping 801 is performed on the technologies of the CR architecture environment 803 and the cloud backend environment 701. The cognitive radio functionality information, such as for example location, regulation, frequency, etc. which can be extracted from a cognitive radio specific database (not shown) can be mapped to, for example, platform API, so that the technology map is:
Location (CR)→Location API
Legislation/Regulation (CR)→Connectivity/Privacy/Security Policies API
Frequency (CR)→NEW (or Bearer API)

In one embodiment, the cognitive radio specific API may consist of location API, Connectivity/Privacy/Security Policies API, frequency API or a combination thereof. As seen above, the frequency API may be a new API at the backend environment 701. Alternatively, the frequency can be mapped to a current Bearer API (not shown). The social network management platform 103 may use sniffing, interrogation or a combination thereof to determine vacant and occupied frequencies with support from cloud environment 701.

In one embodiment, for example, a cognitive radio enabled UE 107a may be associated with a specific location and the connectivity, privacy, security policy rules (API, regulation) with tune up parameters attached to the location. In this embodiment, particular information associated with the location can be extracted from the cloud 111a-111n.

In another embodiment, a cognitive radio enabled UE 107b may be associated with a specific location and the connectivity, privacy, security policy rules (API, regulation) with tune up parameters attached to the location and to a selected frequency. In this embodiment, particular information associated with the location and the frequency can be extracted from the cloud 111a-111n.

In one embodiment, a cognitive radio enabled UE 107c may request direct subscription for device to device communication from location parameters, cloud backend environment Data Manipulation Layer 711 figuring equivalent parameters and enabling these devices to communicate directly. If no DML database exists, a wrapper may be used to provide connection to device storage 715.

In one embodiment, a virtual copy of the local findings and settings of cloud based cognitive radio database can be used at UE level (locally) to allow direct device to device (e.g. UE to UE) cognitive radio connections. The two UEs can form a group in which findings and settings are treated as group findings, and are updated to the backend 701 as well.

In one embodiment, personal or private area settings on a UE 107a may be locally available on a Radio Frequency (RF) memory tag (e.g. home mode, wherein the cognitive radio environment may be more static than other outdoor or public environments), where each cognitive radio enabled UE 107a-107i can pull and push settings for that area from/to RF memory tag. In this embodiment, cognitive radio parameters may be determined periodically or at every touch to the RF memory tag and the determined parameters stored in the RF memory tag for later use and for other UEs to use.

In one embodiment, the privacy enabler 613d and 613b locations in FIG. 8 can be at the edge of the device access to cognitive radio (e.g. between coexistence enabler and TV band device), where privacy policy applied to single device level. Additionally privacy enabler may consist of multiple device privacy policies entering the cognitive radio environment, where privacy policy also takes into account cognitive radio specific coexistence parameters enabling common or separate privacy policies (and privacy zones between those devices). Privacy zone is dependent on cognitive radio location parameter; whether cognitive radio allows computational support to apply certain computational level for this privacy case (e.g. country specific privacy may restrict certain cognitive radio privacy enabler functionality to invalidate particular cognitive radio parameter visibility at that zone, or location).

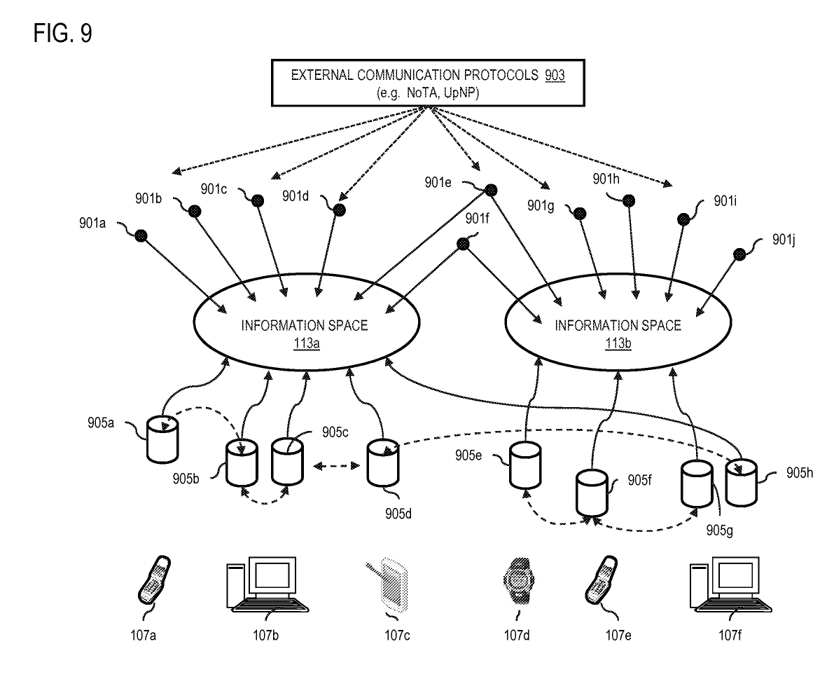

FIG. 9 is a diagram of an information space architecture used for providing cognitive radio information sharing, according to one embodiment. In FIG. 9 two information spaces 113a and 113b are connected to knowledge processors 901a-901j. Some of the knowledge processors such as 901e and 901f are connected to more than one information spaces. In addition, some knowledge processors 901 use external communication protocols 903 outside of the information spaces environment. For example knowledge processors 901c, 901d and 901e may be connected through the NoTA network while knowledge processors 901e, 901g and 901j are connected through UPnP network. The knowledge processors 901a-901j may each consist of components such as user-interfaces, internal logics, connectivity components, etc. (not shown). A knowledge processor 901a-901j may generally run on a single device, even though it may have internal distribution. Such a device may be a mobile device/phone, personal computer, active sensor, Radio Frequency Identification (RFID) tag, etc.

The connectivity component of the knowledge processors 901a-901j (not shown) contains the logic and functionality to communicate to various information spaces 113a-113m. Connectivity is over some network protocol to a semantic information broker (SIB) 905a-905h. A semantic information broker 905a-905h contains the logic for parsing messages and pointers to subscription handlers between the knowledge processors 901a-901j and the information space 113a. A knowledge processor 901a-901j may potentially connect to more than one information spaces at a time thus distributing and synchronizing the operations across all connected information spaces.

The basic functionality provided by the connectivity protocols at this level for manipulating information and for connection to an information space 113a-113m is given below:
Insert: insert information in information space 113a-113m (as an RDF graph) atomically (e.g., at the level of the smallest information element of the information space 113a-113m),
Retract: remove information from information space 113a-113m (as an RDF graph) atomically,
Update: update information on information space 113a-113m (as an RDF graph) atomically—often implemented as a retract and insert through the transaction system,
Query: synchronously (blocking) query; retrieve information from information space 113a-113m,
Subscribe: asynchronously (persistent, non-blocking) set up a subscription to the information space 113a-113m for a given query,
Unsubscribe: terminate a given subscription to information space 113a-113m,
Join: request initiation of an interaction session between a knowledge processor 901 and a given information space 113a-113m,
Leave: terminate the current interaction sessions between a knowledge processor 901 and the information space 113a-113m.

The information space 113a-113m is “virtual” in nature in the sense that its existence is provided by the underlying semantic information brokers 905a-905h which are the elements that “physically” exist. Within the scope of an information space 113a-113m, capabilities for local reasoning over the information contained in that information space are provided through a deductive closure calculation mechanism (not shown). The mechanisms for managing connections and operations of knowledge processors 901a-901j and for distributing the information around information spaces 113a-113m can be implemented by more than one SIB 905 distributed over different processing elements.

The interaction among knowledge processors 901a-901j and information spaces 113a-113m is accomplished by network connections to one or more SIBs 905a-905h providing or representing the information space. As far as the user or designer of a knowledge processor 901a-901j is concerned, there are knowledge processors 901a-901j and information spaces 113a-113m and the connectivity layer abstracts away the physical connection to a SIB 905a-905h.

Additionally the semantic information brokers 905a-905h may be distributed over a number of different devices 107a-107f. For example, SIB 905a is on device 107a and SIBs 905b and 905c are on device 107b. However as seen in FIG. 9 each set of SIBs represent one information space at a time. For example, SIBs 905a-905d and 905h represent information space 113a while SIBs 905e-905g represent information space 113b. Some devices can run more than one SIB representing different information spaces concurrently. For example device 107f runs SIB 905g which represents information space 113b and at the same time runs the SIB 905h that represents information space 113a.

The system can be implemented on various platforms including mobile devices, personal computers, etc. The main requirement of such implementation platforms is that the devices support the runtime environments and that enough processing power and storage is available. Given that knowledge processors 901a-901j can be distributed over devices with more processing power and/or storage as necessary, usually smaller hand-held devices are adequate for running these knowledge processors.

In one embodiment, a SIB 905a-905h may run on systems supporting the Python runtime environment and additionally versions for C++ specifically exist for Linux/Unix and Open-C for Symbian operating system. Client libraries for knowledge processors 901a-901j may exist in Python, C, C++ (Linux/Unix and Symbian) as well as Java. Other environments based on Web services and Javascript can also be used.

In another embodiment, the system implementations run on Mobile Devices (including: N800/810, N95) and personal computers (Unix, Linux, Windows). The knowledge processors 901a-901j can run on sensors, etc. Communication is made over TCP/IP and HTTP protocols which can be used over Ethernet, GPRS and 3G transports.

The information spaces 113a-113m can be represented using Semantic Web standards such as Resource Description Framework (RDF), RDF Schema (RDFS), OWL (Web Ontology Language), FOAF (Friend of a Friend ontology), rule sets in RuleML (Rule Markup Language), etc. For example, RDF is a family of World Wide Web Consortium (W3C) specifications originally designed as a metadata data model. RDF has come to be used as a general method for conceptual description or modeling of information that is implemented in web resources; using a variety of syntax formats. The underlying structure of any expression in RDF is a collection of triples, each consisting of three disjoint sets of nodes including a subject, a predicate and an object. A subject is an RDF Uniform Resource Identifier (URI) reference (U) or a Blank Node (B), a predicate is an RDF URI reference (U), and an object is an RDF URI reference (U), a literal (L) or a Blank Node (B). A set of such triples is called an RDF graph. Table 2 shows sample RDF triples.

TABLE 2

| Subject | Predicate | Object |
|---|---|---|
| uri://. . ./rule#CD-introduction, | rdf:type, | uri://. . ./Rule |
| uri://. . ./rule#CD-introduction, | uri://. . ./rule#assumption, | “c” |

The basic operations on an information store are insertion of a graph, retraction (deletion) of a graph, querying and subscription for information. Insertion and retractions may be combined into a single transactional structure in order to admit atomic updates through the atomic application of retract and insert. All other forms of operations are constructions and refinements of the above. For example, update is constructed out of a set of retracts and inserts. Further rewrite rules can simplify the recurrent application of operations.

In one embodiment, a query is evaluated based on the current snapshot of the information in the information space 113a-113m. Queries can be performed by Wilbur query language (WQL) or simple RDF triple pattern matching. WQL is a lisp-like path based query language. One important difference between WQL and RDF triple pattern matching is that Wilbur's static reasoning engine only runs with WQL queries. WQL queries return a set of RDF graph nodes, while the pattern queries return an RDF graph. Furthermore, other query languages such as SPARQL are also supported.

In another embodiment, subscriptions are implemented as persistent queries, that is, a given query is evaluated whenever the information in the information space 113a-113m changes, and thus the same methods are available. The results are transmitted to the knowledge processors 901a-901j only when they are changed. Depending on parameters, either the full results or a differential is transmitted.

According to the stated ontologies, no attempt is made by the information space 113a-113m to enforce consistency or integrity of information. However, internal reasoning knowledge processors (not shown) may be present which can perform this activity if the information space 113a-113m has been configured accordingly. Information is explicitly semi-structured and may take on any form that the knowledge processors 901a-901j insert or retract.

Presence of typing constructs and namespaces does not necessarily mean that a knowledge processor 901 querying for that information will interpret the information according to the implied ontology. A namespace is an abstract container or environment created to hold a logical grouping of unique identifiers or symbols (e.g. names). The semantics of the information is interpreted by the reader, merely implied by the writer and grounded in the real world context of the knowledge processors 901a-901j. Therefore, any two given knowledge processors may disagree about the semantics. This concept is generally referred to as pragmatic or intentional semantics.

The information spaces 113a-113m provide further functionality regarding the joining and leaving of knowledge processors 901a-901j and policy management. Knowledge processors 901a-901j have a set of credentials which are passed during the “join” operation. The counterparts of the knowledge processor 901a-901j instantiated “leave” and “join” operations are the information spaces 113a-113m instantiated “invite” and “remove” operations. These operations are not necessarily provided by every information space 113a-113m nor understood by every knowledge processor 901a-901j.

Connectivity is provided through a set of listeners which provide access via any given specified transport protocol. TCP/IP is the most used transport, but a Bluetooth based listener or one that uses HTTP/S have also been developed. Listeners can provide pre-processing of the incoming messages if necessary; for example with Bluetooth profiles. Any number of listeners may be provided at any time (at least one is necessary).

Furthermore and in some respects similar to that of the principles of information distribution, the connectivity of an information space 113a-113m can also be seen as a union of all listeners in all SIBs 905a-905h. However, not all listeners may be available on all physical locations (consider Bluetooth or TCP/IP over WLAN for example).

In one embodiment, the social network management platform 103, performs the process described by the flowchart 300 of FIG. 3 to manage cognitive radio information sharing among cognitive radio enabled devices 107a-107f using the information spaces 113a-113m, wherein the information spaces 113a-113m are configured based on the architecture described in FIG. 9.

The processes described herein for providing social network services based on connectivity information may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

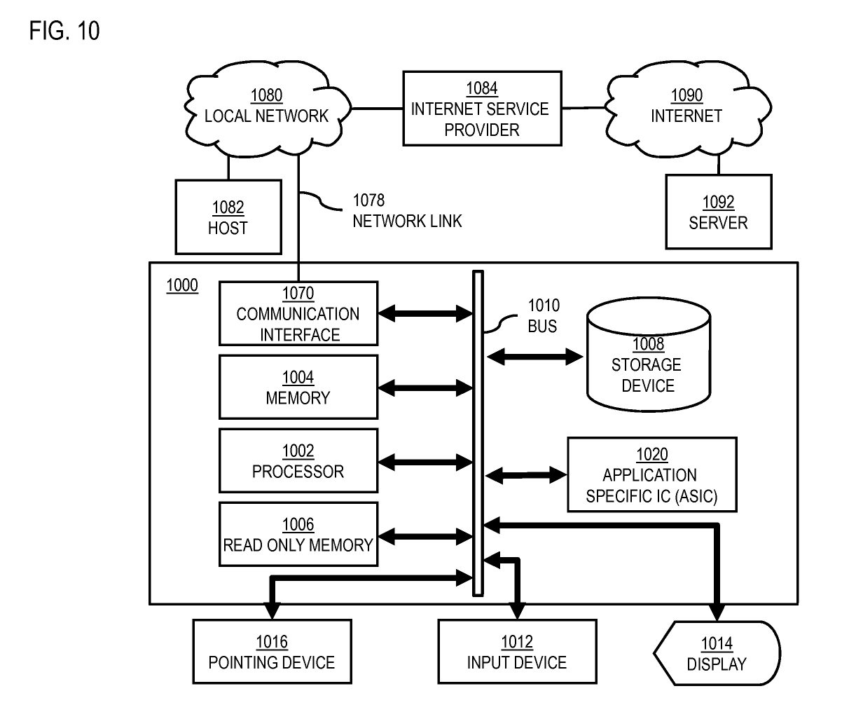

FIG. 10 illustrates a computer system 1000 upon which an embodiment of the invention may be implemented. Although computer system 1000 is depicted with respect to a particular device or equipment, it is contemplated that other devices or equipment (e.g., network elements, servers, etc.) within FIG. 10 can deploy the illustrated hardware and components of system 1000. Computer system 1000 is programmed (e.g., via computer program code or instructions) to provide social network services based on connectivity information as described herein and includes a communication mechanism such as a bus 1010 for passing information between other internal and external components of the computer system 1000. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1000, or a portion thereof, constitutes a means for performing one or more steps of providing social network services based on connectivity information.

A bus 1010 includes one or more parallel conductors of information so that information is transferred quickly among devices coupled to the bus 1010. One or more processors 1002 for processing information are coupled with the bus 1010.

A processor (or multiple processors) 1002 performs a set of operations on information as specified by computer program code related to providing social network services based on connectivity information. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1010 and placing information on the bus 1010. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1002, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1000 also includes a memory 1004 coupled to bus 1010. The memory 1004, such as a random access memory (RAM) or any other dynamic storage device, stores information including processor instructions for providing social network services based on connectivity information. Dynamic memory allows information stored therein to be changed by the computer system 1000. RAM allows a unit of information stored at a location called a memory address to be stored and retrieved independently of information at neighboring addresses. The memory 1004 is also used by the processor 1002 to store temporary values during execution of processor instructions. The computer system 1000 also includes a read only memory (ROM) 1006 or any other static storage device coupled to the bus 1010 for storing static information, including instructions, that is not changed by the computer system 1000. Some memory is composed of volatile storage that loses the information stored thereon when power is lost. Also coupled to bus 1010 is a non-volatile (persistent) storage device 1008, such as a magnetic disk, optical disk or flash card, for storing information, including instructions, that persists even when the computer system 1000 is turned off or otherwise loses power.

Information, including instructions for providing social network services based on connectivity information, is provided to the bus 1010 for use by the processor from an external input device 1012, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 1000. Other external devices coupled to bus 1010, used primarily for interacting with humans, include a display device 1014, such as a cathode ray tube (CRT), a liquid crystal display (LCD), a light emitting diode (LED) display, an organic LED (OLED) display, a plasma screen, or a printer for presenting text or images, and a pointing device 1016, such as a mouse, a trackball, cursor direction keys, or a motion sensor, for controlling a position of a small cursor image presented on the display 1014 and issuing commands associated with graphical elements presented on the display 1014. In some embodiments, for example, in embodiments in which the computer system 1000 performs all functions automatically without human input, one or more of external input device 1012, display device 1014 and pointing device 1016 is omitted.

In the illustrated embodiment, special purpose hardware, such as an application specific integrated circuit (ASIC) 1020, is coupled to bus 1010. The special purpose hardware is configured to perform operations not performed by processor 1002 quickly enough for special purposes. Examples of ASICs include graphics accelerator cards for generating images for display 1014, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1000 also includes one or more instances of a communications interface 1070 coupled to bus 1010. Communication interface 1070 provides a one-way or two-way communication coupling to a variety of external devices that operate with their own processors, such as printers, scanners and external disks. In general the coupling is with a network link 1078 that is connected to a local network 1080 to which a variety of external devices with their own processors are connected. For example, communication interface 1070 may be a parallel port or a serial port or a universal serial bus (USB) port on a personal computer. In some embodiments, communications interface 1070 is an integrated services digital network (ISDN) card or a digital subscriber line (DSL) card or a telephone modem that provides an information communication connection to a corresponding type of telephone line. In some embodiments, a communication interface 1070 is a cable modem that converts signals on bus 1010 into signals for a communication connection over a coaxial cable or into optical signals for a communication connection over a fiber optic cable. As another example, communications interface 1070 may be a local area network (LAN) card to provide a data communication connection to a compatible LAN, such as Ethernet. Wireless links may also be implemented. For wireless links, the communications interface 1070 sends or receives or both sends and receives electrical, acoustic or electromagnetic signals, including infrared and optical signals, that carry information streams, such as digital data. For example, in wireless handheld devices, such as mobile telephones like cell phones, the communications interface 1070 includes a radio band electromagnetic transmitter and receiver called a radio transceiver. In certain embodiments, the communications interface 1070 enables connection to the communication network 105 for providing social network services based on connectivity information to the UEs 107a-107i.

The term “computer-readable medium” as used herein refers to any medium that participates in providing information to processor 1002, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1008. Volatile media include, for example, dynamic memory 1004. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1020.

Network link 1078 typically provides information communication using transmission media through one or more networks to other devices that use or process the information. For example, network link 1078 may provide a connection through local network 1080 to a host computer 1082 or to equipment 1084 operated by an Internet Service Provider (ISP). ISP equipment 1084 in turn provides data communication services through the public, world-wide packet-switching communication network of networks now commonly referred to as the Internet 1090.

A computer called a server host 1092 connected to the Internet hosts a process that provides a service in response to information received over the Internet. For example, server host 1092 hosts a process that provides information representing video data for presentation at display 1014. It is contemplated that the components of system 1000 can be deployed in various configurations within other computer systems, e.g., host 1082 and server 1092.

At least some embodiments of the invention are related to the use of computer system 1000 for implementing some or all of the techniques described herein. According to one embodiment of the invention, those techniques are performed by computer system 1000 in response to processor 1002 executing one or more sequences of one or more processor instructions contained in memory 1004. Such instructions, also called computer instructions, software and program code, may be read into memory 1004 from another computer-readable medium such as storage device 1008 or network link 1078. Execution of the sequences of instructions contained in memory 1004 causes processor 1002 to perform one or more of the method steps described herein. In alternative embodiments, hardware, such as ASIC 1020, may be used in place of or in combination with software to implement the invention. Thus, embodiments of the invention are not limited to any specific combination of hardware and software, unless otherwise explicitly stated herein.

The signals transmitted over network link 1078 and other networks through communications interface 1070, carry information to and from computer system 1000. Computer system 1000 can send and receive information, including program code, through the networks 1080, 1090 among others, through network link 1078 and communications interface 1070. In an example using the Internet 1090, a server host 1092 transmits program code for a particular application, requested by a message sent from computer 1000, through Internet 1090, ISP equipment 1084, local network 1080 and communications interface 1070. The received code may be executed by processor 1002 as it is received, or may be stored in memory 1004 or in storage device 1008 or any other non-volatile storage for later execution, or both. In this manner, computer system 1000 may obtain application program code in the form of signals on a carrier wave.

Various forms of computer readable media may be involved in carrying one or more sequence of instructions or data or both to processor 1002 for execution. For example, instructions and data may initially be carried on a magnetic disk of a remote computer such as host 1082. The remote computer loads the instructions and data into its dynamic memory and sends the instructions and data over a telephone line using a modem. A modem local to the computer system 1000 receives the instructions and data on a telephone line and uses an infra-red transmitter to convert the instructions and data to a signal on an infra-red carrier wave serving as the network link 1078. An infrared detector serving as communications interface 1070 receives the instructions and data carried in the infrared signal and places information representing the instructions and data onto bus 1010. Bus 1010 carries the information to memory 1004 from which processor 1002 retrieves and executes the instructions using some of the data sent with the instructions. The instructions and data received in memory 1004 may optionally be stored on storage device 1008, either before or after execution by the processor 1002.

FIG. 11 illustrates a chip set or chip 1100 upon which an embodiment of the invention may be implemented. Chip set 1100 is programmed to provide social network services based on connectivity information as described herein and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1100 can be implemented in a single chip. It is further contemplated that in certain embodiments the chip set or chip 1100 can be implemented as a single “system on a chip.” It is further contemplated that in certain embodiments a separate ASIC would not be used, for example, and that all relevant functions as disclosed herein would be performed by a processor or processors. Chip set or chip 1100, or a portion thereof, constitutes a means for performing one or more steps of providing user interface navigation information associated with the availability of functions. Chip set or chip 1100, or a portion thereof, constitutes a means for performing one or more steps of providing social network services based on connectivity information.

In one embodiment, the chip set or chip 1100 includes a communication mechanism such as a bus 1101 for passing information among the components of the chip set 1100. A processor 1103 has connectivity to the bus 1101 to execute instructions and process information stored in, for example, a memory 1105. The processor 1103 may include one or more processing cores with each core configured to perform independently. A multi-core processor enables multiprocessing within a single physical package. Examples of a multi-core processor include two, four, eight, or greater numbers of processing cores. Alternatively or in addition, the processor 1103 may include one or more microprocessors configured in tandem via the bus 1101 to enable independent execution of instructions, pipelining, and multithreading. The processor 1103 may also be accompanied with one or more specialized components to perform certain processing functions and tasks such as one or more digital signal processors (DSP) 1107, or one or more application-specific integrated circuits (ASIC) 1109. A DSP 1107 typically is configured to process real-world signals (e.g., sound) in real time independently of the processor 1103. Similarly, an ASIC 1109 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1100 includes merely one or more processors and some software and/or firmware supporting and/or relating to and/or for the one or more processors.

The processor 1103 and accompanying components have connectivity to the memory 1105 via the bus 1101. The memory 1105 includes both dynamic memory (e.g., RAM, magnetic disk, writable optical disk, etc.) and static memory (e.g., ROM, CD-ROM, etc.) for storing executable instructions that when executed perform the inventive steps described herein to provide social network services based on connectivity information. The memory 1105 also stores the data associated with or generated by the execution of the inventive steps.

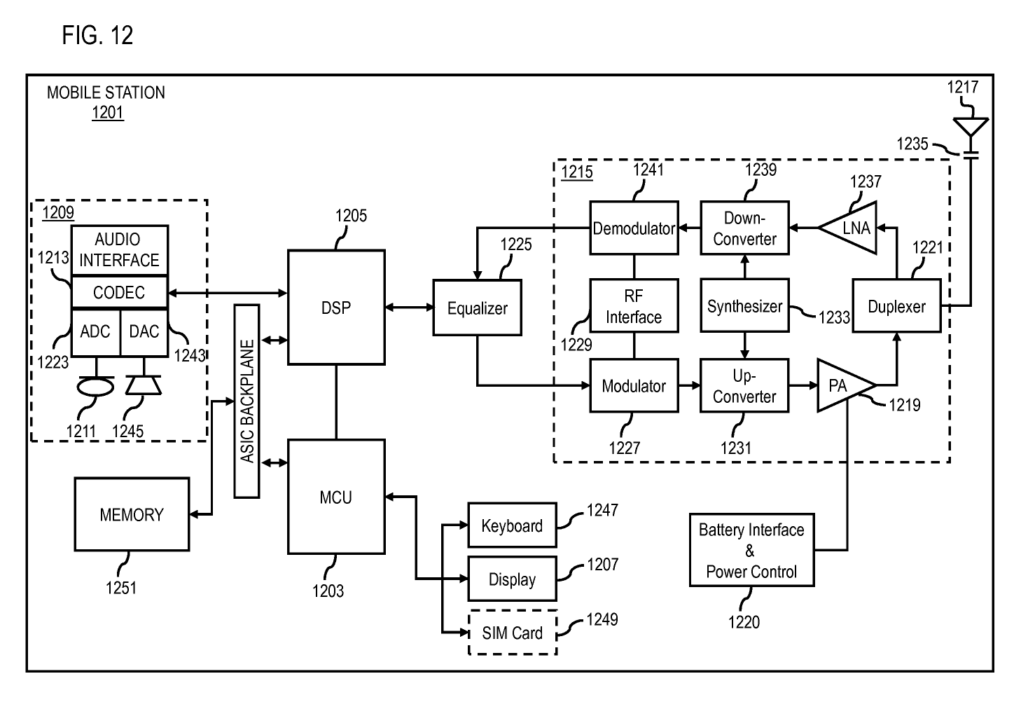

FIG. 12 is a diagram of exemplary components of a mobile terminal (e.g., handset) for communications, which is capable of operating in the system of FIG. 1, according to one embodiment. In some embodiments, mobile terminal 1201, or a portion thereof, constitutes a means for performing one or more steps of providing social network services based on connectivity information. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1203, a Digital Signal Processor (DSP) 1205, and a receiver/transmitter unit including a microphone gain control unit and a speaker gain control unit. A main display unit 1207 provides a display to the user in support of various applications and mobile terminal functions that perform or support the steps of providing social network services based on connectivity information. The display 1207 includes display circuitry configured to display at least a portion of a user interface of the mobile terminal (e.g., mobile telephone). Additionally, the display 1207 and display circuitry are configured to facilitate user control of at least some functions of the mobile terminal. An audio function circuitry 1209 includes a microphone 1211 and microphone amplifier that amplifies the speech signal output from the microphone 1211. The amplified speech signal output from the microphone 1211 is fed to a coder/decoder (CODEC) 1213.

A radio section 1215 amplifies power and converts frequency in order to communicate with a base station, which is included in a mobile communication system, via antenna 1217. The power amplifier (PA) 1219 and the transmitter/modulation circuitry are operationally responsive to the MCU 1203, with an output from the PA 1219 coupled to the duplexer 1221 or circulator or antenna switch, as known in the art. The PA 1219 also couples to a battery interface and power control unit 1220.

In use, a user of mobile terminal 1201 speaks into the microphone 1211 and his or her voice along with any detected background noise is converted into an analog voltage. The analog voltage is then converted into a digital signal through the Analog to Digital Converter (ADC) 1223. The control unit 1203 routes the digital signal into the DSP 1205 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1225 for compensation of any frequency-dependent impairments that occur during transmission though the air such as phase and amplitude distortion. After equalizing the bit stream, the modulator 1227 combines the signal with a RF signal generated in the RF interface 1229. The modulator 1227 generates a sine wave by way of frequency or phase modulation. In order to prepare the signal for transmission, an up-converter 1231 combines the sine wave output from the modulator 1227 with another sine wave generated by a synthesizer 1233 to achieve the desired frequency of transmission. The signal is then sent through a PA 1219 to increase the signal to an appropriate power level. In practical systems, the PA 1219 acts as a variable gain amplifier whose gain is controlled by the DSP 1205 from information received from a network base station. The signal is then filtered within the duplexer 1221 and optionally sent to an antenna coupler 1235 to match impedances to provide maximum power transfer. Finally, the signal is transmitted via antenna 1217 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1201 are received via antenna 1217 and immediately amplified by a low noise amplifier (LNA) 1237. A down-converter 1239 lowers the carrier frequency while the demodulator 1241 strips away the RF leaving only a digital bit stream. The signal then goes through the equalizer 1225 and is processed by the DSP 1205. A Digital to Analog Converter (DAC) 1243 converts the signal and the resulting output is transmitted to the user through the speaker 1245, all under control of a Main Control Unit (MCU) 1203 which can be implemented as a Central Processing Unit (CPU).

The MCU 1203 receives various signals including input signals from the keyboard 1247. The keyboard 1247 and/or the MCU 1203 in combination with other user input components (e.g., the microphone 1211) comprise a user interface circuitry for managing user input. The MCU 1203 runs a user interface software to facilitate user control of at least some functions of the mobile terminal 1201 to provide social network services based on connectivity information. The MCU 1203 also delivers a display command and a switch command to the display 1207 and to the speech output switching controller, respectively. Further, the MCU 1203 exchanges information with the DSP 1205 and can access an optionally incorporated SIM card 1249 and a memory 1251. In addition, the MCU 1203 executes various control functions required of the terminal. The DSP 1205 may, depending upon the implementation, perform any of a variety of conventional digital processing functions on the voice signals. Additionally, DSP 1205 determines the background noise level of the local environment from the signals detected by microphone 1211 and sets the gain of microphone 1211 to a level selected to compensate for the natural tendency of the user of the mobile terminal 1201.

The CODEC 1213 includes the ADC 1223 and DAC 1243. The memory 1251 stores various data including call incoming tone data and is capable of storing other data including music data received via, e.g., the global Internet. The software module could reside in RAM memory, flash memory, registers, or any other form of writable storage medium known in the art. The memory device 1251 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1249 carries, for instance, important information, such as the cellular phone number, the carrier supplying service, subscription details, and security information. The SIM card 1249 serves primarily to identify the mobile terminal 1201 on a radio network. The card 1249 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
a processing of connectivity information associated with one or more devices to determine one or more social networks among the one or more devices; and
at least one determination to cause, to recommend, or a combination thereof a creation, a modification, an initiation, or a combination thereof of the one or more social networks.

2. A method of claim 1, wherein the (1) data and/or (2) information and/or (3) at least one signal are further based, at least in part, on the following:
one or more policies associated with the one or more devices,
wherein the one or more policies include, at least in part, one or more privacy policies, one or more security policies, or a combination thereof; and
wherein the creation, the modification, the initiation, or a combination thereof of the one or more social networks is based, at least in part, on the one or more policies.

3. A method of claim 2, wherein the (1) data and/or (2) information and/or (3) at least one signal are further based, at least in part, on the following:
one or more information items associated with the one or more social networks; and
a sharing of the one or more information items to one or more services, one or more other social networks, one or more other devices within the one or more social networks, or a combination thereof.

4. A method of claim 3, wherein the (1) data and/or (2) information and/or (3) at least one signal are further based, at least in part, on the following:
at least one determination of one or more restrictions associated with the one or more information items based, at least in part, on the one or more policies,
wherein the sharing of the one or more information items is based, at least in part, on the one or more restrictions.

5. A method of claim 4, wherein the (1) data and/or (2) information and/or (3) at least one signal are further based, at least in part, on the following:
at least one determination of a granularity level of the one or more information items based, at least in part, on the one or more restrictions, the one or more policies, or a combination thereof,
wherein the sharing of the one or more information items is based, at least in part, on the granularity level.

6. A method of claim 4, wherein the (1) data and/or (2) information and/or (3) at least one signal are further based, at least in part, on the following:
at least one determination of a set of the one or more devices, the one or more other devices, or a combination thereof to engage in the sharing based, at least in part, on the one or more restrictions, the one or more policies, the one or more granularity level, or a combination thereof.

7. A method of claim 4, wherein the (1) data and/or (2) information and/or (3) at least one signal are further based, at least in part, on the following:
at least one determination of one or more connectivity settings for the one or more social networks, the one or more other social networks, or a combination thereof based, at least in part, on a valuation of the one or more information items.

8. A method of claim 7, wherein the one or more connectivity settings are further based, at least in part, on the one or more restrictions, the one or more policies, one or more other restrictions associated with the one or more other social networks, one or more other policies, or a combination thereof.

9. A method of claim 1, wherein the (1) data and/or (2) information and/or (3) at least one signal are further based, at least in part, on the following:
processing and/or facilitating a processing of the connectivity information to determine one or more connectivity parameters for the one or more devices; and
determining a similarity of the one or more connectivity parameters among the one or more devices,
wherein the one or more social networks are determined based, at least in part, on the similarity information.

10. A method of claim 1, wherein the (1) data and/or (2) information and/or (3) at least one signal are further based, at least in part, on the following:
a processing of the connectivity information to determine a number of connections, a type of connections, a duration of connections, or a combination thereof among the one or more devices,
wherein the one or more social networks are determined based, at least in part, on the number of connections, the type of connections, the duration of connections, or a combination thereof.

11. An apparatus comprising:
at least one processor; and
at least one memory including computer program code for one or more programs,
the at least one memory and the computer program code configured to, with the at least one processor, cause the apparatus to perform at least the following,
process and/or facilitate a processing of connectivity information associated with one or more devices to determine one or more social networks among the one or more devices; and
determine to cause, to recommend, or a combination thereof a creation, a modification, an initiation, or a combination thereof of the one or more social networks.

12. An apparatus of claim 11, wherein the apparatus is further caused to:
determine one or more policies associated with the one or more devices,
wherein the one or more policies include, at least in part, one or more privacy policies, one or more security policies, or a combination thereof; and
wherein the creation, the modification, the initiation, or a combination thereof of the one or more social networks is based, at least in part, on the one or more policies.

13. An apparatus of claim 12, wherein the apparatus is further caused to:
determine one or more information items associated with the one or more social networks; and
cause, at least in part, a sharing of the one or more information items to one or more services, one or more other social networks, one or more other devices within the one or more social networks, or a combination thereof.

14. An apparatus of claim 13, wherein the apparatus is further caused to:
determine one or more restrictions associated with the one or more information items based, at least in part, on the one or more policies,
wherein the sharing of the one or more information items is based, at least in part, on the one or more restrictions.

15. An apparatus of claim 14, wherein the apparatus is further caused to:
determine a granularity level of the one or more information items based, at least in part, on the one or more restrictions, the one or more policies, or a combination thereof,
wherein the sharing of the one or more information items is based, at least in part, on the granularity level.

16. An apparatus of claim 14, wherein the apparatus is further caused to:
determine a set of the one or more devices, the one or more other devices, or a combination thereof to engage in the sharing based, at least in part, on the one or more restrictions, the one or more policies, the one or more granularity level, or a combination thereof.

17. An apparatus of claim 14, wherein the apparatus is further caused to:
determine one or more connectivity settings for the one or more social networks, the one or more other social networks, or a combination thereof based, at least in part, on a valuation of the one or more information items.

18. An apparatus of claim 17, wherein the one or more connectivity settings are further based, at least in part, on the one or more restrictions, the one or more policies, one or more other restrictions associated with the one or more other social networks, one or more other policies, or a combination thereof.

19. An apparatus of claim 11, wherein the apparatus is further caused to:
process and/or facilitate a processing of the connectivity information to determine one or more connectivity parameters for the one or more devices; and
determine a similarity of the one or more connectivity parameters among the one or more devices,
wherein the one or more social networks are determined based, at least in part, on the similarity information.

20. An apparatus of claim 11, wherein the apparatus is further caused to:
process and/or facilitate a processing of the connectivity information to determine a number of connections, a type of connections, a duration of connections, or a combination thereof among the one or more devices,
wherein the one or more social networks are determined based, at least in part, on the number of connections, the type of connections, the duration of connections, or a combination thereof.

21-48. (canceled)
